(19) United States
(12) Patent Application Publication
(10) Pub. No.: US 2026/0158726 A1
(43) Pub. Date: Jun. 11, 2026

(54) POLYMER COMPOSITES FOR FUSED FILAMENT DEPOSITION

(71) Applicant: MATSYS Incorporated, Sterling, VA (US)

(72) Inventors: Cagri Oztan, Sterling, VA (US); Pascal Dubé, Chantilly, VA (US)

(73) Assignee: MATSYS Incorporated, Sterling, VA (US)

(21) Appl. No.: 19/410,061

(22) Filed: Dec. 5, 2025

Related U.S. Application Data
(60) Provisional application No. 63/729,003, filed on Dec. 6, 2024.

(51) Int. Cl. B29C 48/05; B29C 48/00; B29C 64/118; B29C 64/209; B29K 79/00; B29K 505/08

(52) U.S. Cl. CPC B29C 48/05; B29C 48/022; B29C 64/118; B29C 64/209; B29K 2079/085; B29K 2505/08; B29K 2995/0063

(57) ABSTRACT

Disclosed is a composite filament with high densities designed for additive manufacturing. The composite filament can be used with for fused filament fabrication. Additionally disclosed are methods for its production and application. The composite filament comprises a continuous elongate structure made from a polymer binder (e.g., a high glass transition temperature polymer) combined with various metals at adjustable concentrations. The filament is created by extruding a mixture of polymer and metal, allowing customization of the filament's density through compositional adjustments. Additionally, the disclosure encompasses three-dimensional objects produced with the filament and the processes for their fabrication.

This application claims the benefit of U.S. Provisional Application Ser. No. 63/729,003 filed Dec. 6, 2024, the contents of which are incorporated herein by reference.

### BACKGROUND

### 1. Field

Disclosed embodiments are related to the field of 3D printing. In particular, disclosed embodiments are related to the field of using composite, metal-loaded thermoplastic filaments for 3D printing.

### 2. Description of the Related Art

Apparatuses in accordance with exemplary embodiments pertain to methods for producing materials used in 3D printing. Specifically, these apparatuses involve a method for manufacturing metal-loaded thermoplastic filaments.

In product development, 3D printing is valued for its rapid and efficient approach to prototyping parts before they advance to full-scale manufacturing.

While 3D printing enables testing of form and fit, allowing for any necessary design or engineering adjustments before production, there are limitations to the technology as well.

These limitations include a restricted range of material options and concerns about whether the print properties align with the intended application.

Typically, thermoplastics are used in 3D printing due to their ability to be deposited in molten layers to form parts. However, thermoplastic parts have significantly lower densities and strength, requiring innovative solutions for severe conditions.

Simplified tools or processes to enhance these functional and mechanical characteristics for 3D printing would therefore be beneficial.

### SUMMARY

An aspect of the disclosure is a filament for use with 3D printing. The filament comprising: a metal powder; a polymer binder; wherein the metal powder and the polymer binder are combined in a mixture; wherein the mixture is adapted to form an elongated object; and wherein a density of the elongated object is equal to or greater than 7.9 g/cm³.

Another aspect of the disclosure is a method of manufacturing a filament. The method comprising: mixing a metal powder and a polymer binder to form a mixture; and extruding the mixture to form an elongated object, wherein a density of the elongated object is equal to or greater than 7.9 g/cm³.

Still yet another aspect of the disclosure is a method for 3D printing. The method comprising: loading a filament into a nozzle, wherein the filament comprises; a metal powder; polymer binder; wherein the metal powder and the polymer binder are combined to form an elongated object, wherein a density of the elongated object is equal to or greater than 7.9 g/cm³; heating the filament; and forming an item.

An aspect of the disclosure is a method for manufacturing a metal-infused thermoplastic filament for 3D printing. The method involves placing a mixture of metal powder and thermoplastic into the hopper of an extrusion device.

Another aspect of the disclosure includes introducing a thermoplastic material mixed with metal into an extruder. The metal-thermoplastic mixture is passed through an extensional flow die. The metal-thermoplastic mixture is then extruded through a shaping die to create a continuous filament extrudate.

In an embodiment of the disclosure the extruder is a single-screw type. In another embodiment of the disclosure, the extruder is a low-compression and low-shear extruder. In another embodiment, the metal-containing material is shredded prior to mixing it with the thermoplastic.

In another embodiment, the thermoplastic is in pellet form, while the metal is provided as a powder. In an embodiment, extrudate is drawn through a second drawing die after the shaping die.

In an embodiment, the shaping die has an initial extrudate diameter, while the second drawing die reduces the extrudate to a smaller diameter. In an embodiment, the method includes cooling the filament as it is extruded through the at least one die.

Another aspect of the disclosure includes a metal-reinforced thermoplastic filament for 3D printing produced using this method. Still another aspect of the disclosure is a filament for use with 3D printing. The filament comprising a metal powder; a polymer binder; wherein the metal powder and the polymer binder are combined in a mixture; wherein the mixture is adapted to form an elongated object; and wherein a density of the elongated object is equal to or greater than 7.9 g/cm³.

Yet another aspect of the disclosure is a method of manufacturing a filament. The method comprising: mixing a metal powder and a polymer binder to form a mixture; and extruding the mixture to form an elongated object, wherein a density of the elongated object is equal to or greater than 7.9 g/cm³.

Still yet another aspect of the disclosure, is a method for 3D printing comprising: loading a filament into a nozzle, wherein the filament comprises; a metal powder; a polymer binder; wherein the metal powder and the polymer binder are combined to form an elongated object, wherein a density of the elongated object is equal to or greater than 7.9 g/cm³; heating the filament; and forming an item.

Additional features, aspects, and advantages of the disclosure will become clear upon reviewing the following description and accompanying drawings, where reference numbers denote the same component, element, or feature.

### BRIEF DESCRIPTION OF THE DRAWINGS

The embodiments of the disclosure are illustrated in the description as set forth hereinafter, with reference to the pertinent drawings, where:

FIG. 1 is an illustration of the system for forming the composite filament

FIG. 2 demonstrates an extruding system in accordance with an embodiment for forming the composite filament.

FIG. 3 is a flow chart showing a method for producing a metal and thermoplastic composite filament for 3D printing in accordance with an embodiment.

FIG. 4 is an illustration of layer-by-layer deposition of the extruded filament using a heated nozzle for part manufacturing.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components that would perform the same or a similar function as the components described herein are intended to be embraced within the scope of embodiments of the present disclosure.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof as used herein, the term “may” with respect to a material, structure, feature or method act indicates that such is contemplated for use in implementation of an embodiment of the invention and such term is used in preference to the more restrictive term “is” so as to avoid any implication that other, compatible materials, structures, features and methods usable in combination therewith should or must be, excluded.

The present invention pertains to the development of metal-polymer composite filaments designed for use in additive manufacturing processes, specifically 3D printing technologies such as fused filament fabrication (FFF) or fused deposition modelling (FDM). The composite filaments disclosed herein are characterized by their high density, which is comparable to or exceeds that of steel. The composite filaments are composed of a homogenous mixture of metal powders and one or many polymer binders, which together provide the resulting printed objects with enhanced physical properties and structural integrity. The composite filament is an elongated object formed from metal and polymer components.

The first step involves thoroughly mixing the selected metal powders with a polymer binder. The metal powders are added in a proportion that typically ranges from 40% to 95% by weight of the mixture, depending on the desired final density of the filament. The mixing process preferably should provide a homogenous distribution of the metal powders within the polymer matrix to achieve uniform properties throughout the composite filament.

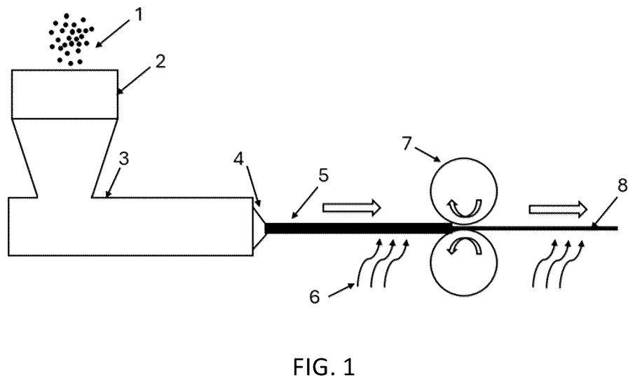

FIG. 1 illustrates a schematic of the extruder device 3 and the process for producing a composite filament 8 that is a metal-infused thermoplastic filament. The feedstock 1 for this process typically comprises a thermoplastic polymer and metal powder. This feedstock 1 may comprise separate thermoplastic and metal components, or a pre-mixed thermoplastic composite already containing metal powder. The feedstock 1 is introduced into the extruder device 3 through a hopper 2 or an advanced feeding system, such as a gravimetric starve feeder. In an embodiment, inside the extruder, the material is homogenized in a design optimized for mixing. The extrudate 5 is then pushed or drawn from the extruder device 3 through one or more orifices in the die 4. Controlled heating and cooling devices 6 regulate the extrudate's 5 temperature as it exits the extruder. The resulting filament 8 is then wound onto a reel for collection.

The feedstock 1 combines a thermoplastic polymer with metal powder, either as a pre-mixed composite, as separate components, or as a blend of both. Pre-mixed materials may include, but are not limited to, shredded thermoplastic pellets with metal powders of varying sizes. The thermoplastic polymer in the feedstock 1 may be in pellet or powder form. Types of metal that can be used include, but are not limited to, tantalum, tungsten, molybdenum, nickel, zirconium, aluminum, and boron.

In an embodiment, fabrication of filaments with 90 wt. % tungsten in a polyvinylidene fluoride (PVDF) matrix is achieved, with the filaments enabling a density of 9.3 g/cc which is more than the density of stainless steel.

In an embodiment, filaments with 94 wt. % tungsten in a polylactic acid (PLA) matrix are obtained, with a filament density of 10.2 g/cc. In a separate embodiment, the combination of 84 wt. % tantalum, 8 wt. % zirconium and 8 wt. % polyetheretherketone (PEEK) produces a filament of 8 g/cc.

In an embodiment of the invention, the judicious selection of metal particles with unique properties, including particles with sizes below 50 microns, leads to the formation of a uniform filament possessing flexibility while being printable on standard benchtop FDM printers. Some of the properties that may be selected for may involve a combination of particle morphology (shape) and particle size. In an embodiment, the selected metal particles are spherical in nature. In an embodiment, bimodal or trimodal particle size distribution is used to ensure homogenous dispersion at high metal loadings.

The polymer binders employed in the composite filaments serve to hold the metal powders together during processing and printing, providing the necessary flexibility and strength for filament extrusion and subsequent 3D printing.

In some embodiments, the polymer binder comprises a collective of different polymers mixed in order to achieve a specific set of properties, such as melting point, viscosity or strength amongst a few.

In some embodiments, the choice of polymer binder is made based on the desired mechanical properties, ease of processing, and compatibility with the selected metal powders. Preferably, the binder is capable of adequately wetting the metal powder particles to ensure uniform distribution and strong adhesion within the composite material.

The thermoplastic polymer (matrix) may include, but is not limited to, polyamide (PA), polyetheretherketone (PEEK), polyetherketone (PEK), polyphenylene sulfide (PPS), polyethersulfone (PES), thermoplastic polyurethane (TPU), polypropylene (PP), their copolymers, and combinations thereof.

In some embodiments, polymer binders are selected for specific molecular weights, chain lengths, linear to branch ratios and other properties affecting their ability to be mixed uniformly with selected metal powders.

In embodiments, a polymer mixture may be used to refine the properties of the filament with respect to flow, melt temperature or print quality.

It will be recognized by experts in the art that the metal powders may be used individually or in combination, depending on the specific requirements of the end-use application. The particle size distribution, shape, and surface characteristics of the metal powders are optimized to ensure a uniform distribution within the polymer matrix and to facilitate the extrusion process.

The manufacturing process for the metal-polymer composite filament involves several steps to ensure the production of a high-quality filament with the desired density and mechanical properties.

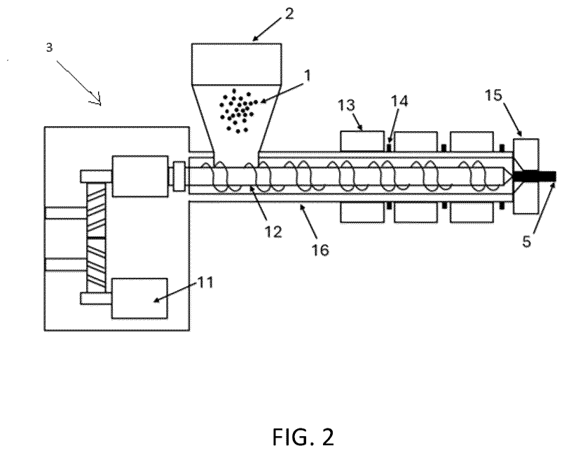

FIG. 2 presents a schematic of additional components of an extruder device 3 used to manufacture metal-loaded thermoplastic composite filament for 3D printing, according to an exemplary embodiment. This extruder device 3 ensures consistent flow of the metal-thermoplastic mixture. Suitable extruder types for effective mixing may include, but are not limited to, low-shear or low-compression designs. Examples include single-screw, tangential twin-screw, non-intermeshing twin-screw, conical twin-screw, or reciprocating single-screw (Buss Kneader) configurations. Each screw design is optimized to enhance the flow of the thermoplastic-metal mixture. The extrudate 5 feed from the extruder device 3 may be continuous or utilize a reciprocating design, where a charge of molten material accumulates and is then pushed through the exit die 4 once a specific charge mass is reached. In this embodiment, the extruder device 3 is either a single-screw or a low-compression, low-shear extruder and may incorporate technologies that ensure homogeneous mixing and flow.

The extruder device 3 is equipped with heating elements 13 and thermocouples 14 to generate and monitor heat. An extrusion screw 15 within the barrel 16 drives the metal-thermoplastic feedstock mixture 1 from the material feed hopper 2 to at least one shaping die 15 at the barrel's end. The barrel 16 or extrusion screw 12 may feature convergent or divergent designs to aid in heating and homogenizing the material.

As the extrusion screw 12 rotates, powered by a motor and pulley system 11, the mixture 1 moves through the barrel 16, heated by the elements 16 until it melts into a molten thermoplastic-metal composite. This molten composite is then forced through the shaping die 15 to form a filament extrudate 5. The shaping die 15 is designed to ensure a uniform cross-section, with an extensional flow die having a gradual taper to regulate extrusion rates, unlike a simple plate die with a sharper angle.

In another aspect of the exemplary embodiment, the filament extrudate 5 may be drawn from the shaping die 15 through rotating drawing mandrels 7 at the end of the extruder. Drawing the filament through mandrels 7 reduces the diameter, further ensuring geometric consistency of the extrudate 5 and allowing the drawing die 4 and mandrels 7 to consolidate the extrudate, reducing porosity.

After exiting the extruder device 3, the extrudate 5 can be further drawn to achieve the desired diameter for 3D printing, typically 3.0 mm or 1.5 mm. The shaping dies 15, 14 and mandrel 7 designs enable the creation of filaments with a range of continuous diameters. The drawing process may involve additional heating or cooling 6 following the extruder. This process has multiple benefits: it allows for a larger shaping die diameter, reducing extrusion pressure and energy requirements, while minimizing shear on the metal powder, which decreases internal porosity. Drawing also enhances the filament's mechanical properties, such as strength, stiffness, and strain to failure, making it more durable for handling and use in a 3D printer. Each component of the extruder device 3 is optimized to facilitate efficient material flow.

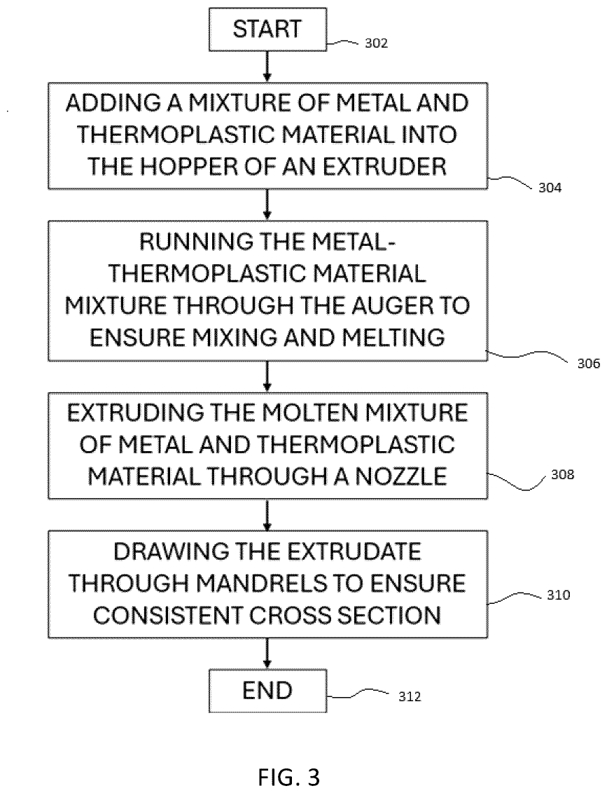

FIG. 3 is a flow chart showing a method for producing a metal and thermoplastic composite filament for 3D printing in accordance with an embodiment. In step 302 the method for forming the composite filament begins. In step 304 a mixture of metal and thermoplastic material is added into the hopper of an extruder. In step 306 the metal and thermoplastic material mixture is run through an auger to ensure mixing and melting. In step 308 the molten mixture of metal and thermoplastic is extruded through a nozzle. In step 310 the extrudate is drawn through mandrels to ensure a consistent cross section. In step 312 the method ends.

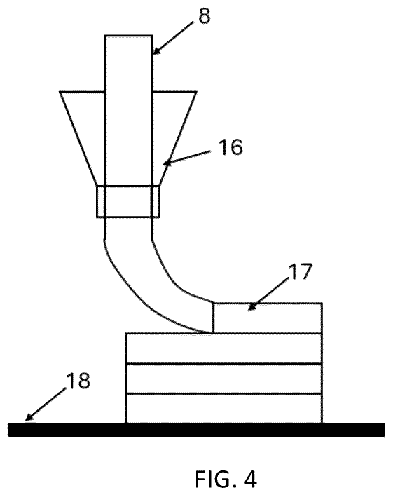

FIG. 4 shows composite filament 8 being loaded into a 3D printer nozzle 16, where it is heated to a temperature above the melting point of the polymer binder. The molten filament 17 is deposited layer by layer onto the print bed 18, forming the desired object. The printing parameters, including temperature, print speed, and layer thickness, are optimized to achieve the best possible mechanical properties, surface finish, and dimensional accuracy in the printed object.

The resulting 3D printed objects produced from the composite filament of the present invention exhibit densities comparable to or exceed those of traditional steel parts. These objects are suitable for use in various applications, including but not limited to aerospace, defense, medical devices, and industrial components.

Wherever possible, the same or like reference numbers are used throughout the drawings to refer to the same or like features. It should be noted that the drawings are in simplified schematic form and are not drawn to precise scale.

Throughout this disclosure, various embodiments of the present invention can be presented in a range format. It should be understood that the description in range format is merely for convenience and brevity and should not be construed as an inflexible limitation on the scope of the present invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of exemplary embodiments may be combined in any suitable manner in one or more embodiments. One skilled in the art will recognize, in light of the description herein, that the exemplary embodiments can be practiced without one or more of the specific features or advantages of a particular embodiment. In other instances, additional features and advantages may be recognized in certain embodiments that may not be present in all embodiments of the present disclosure.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in any order as desired.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A filament for use with 3D printing, comprising:
a metal powder;
a polymer binder;
wherein the metal powder and the polymer binder are combined in a mixture;
wherein the mixture is adapted to form an elongated object; and
wherein a density of the elongated object is equal to or greater than 7.9 g/cm³.

2. The filament of claim 1, wherein the metal powder is selected from the group consisting of tungsten, tantalum, zirconium, molybdenum, nickel, and iron.

3. The filament of claim 1, wherein the metal powder comprises at least one of tungsten, tantalum, zirconium, molybdenum, nickel, and iron.

4. The filament of claim 1, wherein the polymer binder is selected from the group consisting of polyamide, polyetheretherketone, polylactic acid, polycarbonate, acrylonitrile butadiene styrene, polyvinylfluoride, and polyvinyldifluoride.

5. The filament of claim 1, wherein the polymer binder comprises at least one of of polyamide, polyetheretherketone, polylactic acid, polycarbonate, acrylonitrile butadiene styrene, polyvinylfluoride, and polyvinyldifluoride.

6. The filament of claim 1, wherein the metal powder forms greater than 90% by weight of the elongated object.

7. The filament of claim 6, wherein the metal powder is tungsten.

8. The filament of claim 7, wherein the polymer binder is a polyvinylidene fluoride (PVDF) matrix.

9. The filament of claim 7, wherein the polymer binder is a polylactic acid (PLA) matrix.

10. The filament of claim 1, wherein a diameter of the elongated object is between 1.5 mm to 3.0 mm.

11. The filament of claim 1, wherein the elongated object has a uniform cross-section along its entire length.

12. The filament of claim 1, wherein the metal powder forms between 40-95% by weight of the elongated object.

13. The filament of claim 1, wherein the metal powder is tungsten and at least one other metal powder is zirconium.

14. The filament of claim 12, wherein the polymer binder is polyetheretherketone.

15. A method of manufacturing a filament comprising:
mixing a metal powder and a polymer binder to form a mixture; and
extruding the mixture to form an elongated object, wherein a density of the elongated object is equal to or greater than 7.9 g/cm³.

16. The method of claim 15, wherein the metal powder comprises at least one of tungsten, tantalum, molybdenum, nickel, and iron.

17. The method of claim 15, wherein the polymer binder comprises at least one of of polyamide, polyetheretherketone, polylactic acid, polycarbonate, acrylonitrile butadiene styrene, polyvinylfluoride, and polyvinyldifluoride.

18. The method of claim 15, wherein the metal powder forms between 60-95% by weight of the elongated object.

19. The method of claim 17, wherein the metal powder is tungsten.

20. A method for 3D printing comprising:
loading a filament into a nozzle, wherein the filament comprises;
a metal powder;
a polymer binder;
wherein the metal powder and the polymer binder are combined to form an elongated object, wherein a density of the elongated object is equal to or greater than 7.9 g/cm³;
heating the filament; and
forming an item.
